(19) United States
(12) Patent Application Publication
(10) Pub. No.: US 2015/0021814 A1
(43) Pub. Date: Jan. 22, 2015

(54) CORE/SHELL FLUOROPOLYMER

(71) Applicant: E I DU PONT DE NEMOURS AND COMPANY, Wilmington, DE (US)

(72) Inventors: Ralph Munson Aten, Chadds Ford, PA (US); Heidi Elizabeth Burch, Bear, DE (US)

(21) Appl. No.: 14/377,664

(22) PCT Filed: Feb. 6, 2013
(86) PCT No.: PCT/US13/24872

§ 371 Date: Aug. 8, 2014

Related U.S. Application Data
(60) Provisional application No. 61/596,397, filed on Feb. 8, 2012.

(51) Int. Cl. B29C 71/02; C08L 27/18

(52) U.S. Cl. CPC C08J 7/08; C08L 27/18; C08J 2427/18; C08J 2327/12; C08L 2205/02
USPC 264/234; 428/402.24

(57) ABSTRACT

A core/shell polymer is provided and is optionally heat aged, wherein the core comprises one of (a) melt-fabricable tetrafluoroethylene/perfluoro(alkyl vinyl ether) copolymer and (b) melt-processible polytetrafluoroethylene and the shell comprises the other of (a) and (b), wherein the amount of (b) in said core/shell polymer is 15 to 45 wt % based on the total weight of (a) and (b) whether (b) is the core or shell of the core/shell polymer.

### FIELD OF INVENTION

This invention relates to a combination of melt-processible polytetrafluoroethylene with melt-fabricable tetrafluoroethylene/perfluoro(alkyl vinyl ether) copolymer that provides improved tensile strength.

### BACKGROUND OF INVENTION

U.S. Pat. No. 6,436,533 discloses the dry blending of PTFE and PFA, followed by melt extruding the dry blend as pellets which can then be melted for melt spinning into fiber or the combination of melt extrusion with melt spinning without the intermediate pellet formation (col. 4, l. 21-35). Extrusion of the dry blend accomplishes melt mixing of the separately supplied PTFE and PFA. Alternatively, the PTFE and PFA can be fed to separate extruders which in turn feed a mixing device such as a third extruder to form a blend of the PTFE and PFA, which can then be melt spun into fiber (col. 4, l. 46-51). The PTFE is disclosed to be low in molecular weight so that it exhibits a melt viscosity that is close to that of the PFA so as to permit melt mixing (col. 3, l. 48-50). The low melt viscosity enabling the PTFE to be melt processed, resulting from the low molecular weight of the PTFE, prevents this PTFE from being molded into articles that exhibit useful strength (col. 1, l. 23-25). The absence of strength of articles molded from melt-processible PTFE is demonstrated in '533 by the disclosure of the inability to melt spin melt-processible FIFE, i.e. the brittleness of the filament causes it to break into solidified segments, this brittleness indicating the virtually zero strength of the melt processible PTFE (col. 8, l. 8-12). Indeed, the Zonyl® PTFE products used in '533 (cal. 5 l. 52-55) are advertised as fluoroadditives and lubricant powders, not as molding products. The PFA of '533 is disclosed to be poly(tetrafluoroethylene/perfluoro(alkyl vinyl ether) that is melt formable such as by melt extrusion and which exhibits a melt flow rate characteristic of melt formability of 0.5-500 /10 min at 372° C. (col. 3, l. 15-25).

FIG. 7 of '533 discloses that the addition of the melt processible PTFE to the PFA essentially causes the reduction in tensile strength of the PFA, characterized in FIG. 7 as a decrease in tenacity as the amount of PTFE additive increases from 5 wt %.

### SUMMARY OF INVENTION

It has been discovered that when melt-fabricable tetrafluoroethylene/perfluoro(alkyl vinyl ether) copolymer and melt-processible polytetrafluoroethylene are combined as core/shell polymer instead of melt mixing of separately supplied polymers, the resultant composition exhibits a higher tensile strength. Thus, one embodiment of the present invention is a core/shell polymer wherein the core comprises one of (a) melt-fabricable tetrafluoroethylene/perfluoro(alkyl vinyl ether) copolymer and (b) melt-processible polytetrafluoroethylene and the shell comprises the other of (a) and (b), wherein the amount of (b) in said core/shell polymer is 15 to 45 wt % based on the total weight of (a) and (b),

It has also been discovered that when the resultant composition is heat aged, the tensile strength of the composition is increased even more. Thus, another embodiment of the present invention is the process comprising heat aging a core/shell polymer wherein the core comprises one of (a) melt-fabricable tetrafluoroethylene/perfluoro(alkyl vinyl ether) copolymer and (b) melt-processible polytetrafluoroethylene and the shell comprises the other of (a) and (b), wherein the amount of (b) in said core/shell polymer is 15 to 45 wt % based on the total weight of (a) and (b)to increase the tensile strength of said polymer.

In both embodiments, (a) and (b) are the polymer components of the core/shell polymer and the amount of (b) in said core/shell polymer applies whether (b) is the core or the shell of said core/shell polymer. Accordingly, the amount of (a) is correspondingly 85 to 55 wt % based on the total weight of (a) and (b).

Both embodiments have the following aspects: when (a) is said core, then (b) is said shell, and when (b) is said core, then (a) is said shell.

The following preference applies to both embodiments and these aspects thereof: the core/shell polymer exhibits a melt flow rate of 4 g/10 min or greater.

The increase in tensile strength is preferably 10% or greater as compared to the same composition insofar as polymer components and amounts are concerned but obtained by melt mixing of the polymer components supplied as separate polymers. This increase in tensile strength is obtained without heat aging of the core/shell polymer. The tensile strengths disclosed here are without heat aging unless otherwise indicated.

Heat aging of the core/shell polymer is preferably carried out to be effective in further increasing the tensile strength of the core/shell polymer preferably by 10% or greater as compared to the same polymer without heat aging (unaged).

### DETAILED DESCRIPTION OF INVENTION

The components (a) and (b) of the core/shell polymer are both polymers in that both components are prepared by polymerization, whereby the core/shell polymer is also prepared by polymerization. In the case of polymer component (a) being the core, the polymerization is conducted to first form the core of this polymer, followed by polymerization to then form the shell of polymer component (b) covering the core of the core/shell polymer. In the case of polymer component (b) being the core, the polymerization is conducted to first form the core of this polymer, followed by polymerization to then form the shell of polymer component (a) of the core/shell polymer. Preferably, the polymerization is aqueous dispersion polymerization, wherein the core/shell polymer is obtained as dispersed particles in the aqueous polymerization medium. Preferably, these particles have a raw dispersion particle size (RDPS) of 0.300 micrometers or less and preferably at least 0.100 micrometers. RDPS is determined by the laser light scattering method of ASTM D4464.

Polymer component (a) or polymer component (b) forming the core can be prepared in a polymerization medium that is separate from the polymerization forming the shell polymer component, and this core can be used to seed the polymerization of the polymer component forming the shell, i.e. polymer component (b) forming the shell in the case of polymer component (a) forming the core, and polymer component (a) forming the shell in the case of polymer component (b) forming the core. Alternatively, the core and shell are sequentially formed in the same aqueous dispersion polymerization medium. The polymerization to form the core can be run to completion by measures including the stopping of the feed of monomer to the polymerization reactor. Unreacted monomer can be vented off from the reactor. Alternatively, the polymerization system for the shell polymer is established while maintaining the TFE feed to the polymerization reactor after formation of the core polymer component.

In any event, the polymerization conditions for forming the core and shell polymer components can be those used to form the polymer desired as though such polymer is being formed by itself, not as a core or shell of the core/shell polymer. The polymerizations to make the core and shell polymers separately from one another are a convenient way to provide these polymers separately from one another, so that they can be available for chemical and property analyses. These analyses are then applicable to the polymer components (a) and (b) made by the same polymerizations, but conducted sequentially to form the core/shell polymer.

The amount of core and shell in the core/shell polymer can be determined by the weight of the monomer(s) consumed in the polymerization reaction forming each of the core and shell. Tetrafluororethylene (TFE) will be consumed in both polymerizations, this monomer being used to make both the melt-processible polytetrafluoroethylene and the tetrafluoroethylene/perfluoro(alkyl vinyl ether) copolymer. The relative amounts of TFE consumed in the polymerizations to make the core and shell give an approximate estimate of the wt % of the core and shell. When the copolymerized perfluoro(alkyl vinyl ether) monomer is included in the calculation of the amount of polymer (a) formed, the accuracy of the calculation is improved.

The dispersed particles of core/shell polymer in the aqueous polymerization medium are the primary particles, preferably having the RDPS mentioned above. Typically the dispersion of particles is recovered from the aqueous medium by coagulation, which causes the primary particles to agglomerate, followed by separation from the aqueous medium and drying to form much larger secondary particles of agglomerated primary particles. Typically the secondary particles will have an average particle size of at least 200 micrometers as determined by the dry sieve analysis disclosed in U.S. No. Pat. 4,722,122. Melting of the core/shell polymer whether present as a mass of primary particles or secondary particles causes the core/shell polymer to lose its core/shell identity and particulate form to become a composition, which is a melt blend derived from the core/shell polymer of the present invention. The composition of the melt blend is the same as the composition of the core/shell polymer. The polymer component (a) being the major component of the core/shell polymer, forms the matrix for the melt blend, within which the melt-processible PTFE is dispersed, whether the tetrafluoroethylene/perfluoro(alkyl vinyl ether) copolymer component is supplied to the melt as the core or the shell of the core/shell polymer. The melt-processible PTFE component is already blended with the tetrafluoroethylene/perfluoro(alkyl vinyl ether) copolymer component because of the core/shell combination of these polymers as supplied to the melt. The melt blend will preferably involve melt mixing as is characteristic by such melt fabrication processes as extrusion and injection molding.

The core/shell polymer and its melt blend composition exhibit two melting temperatures, one for polymer component (a) and the other for polymer component (b), suggesting that polymer component (b) has a separate identity from polymer component (a) as would arise from a dispersion of polymer component (b) as particles within the PFA (polymer component (a)) matrix. These particles arise whether the polymer component (b) is the core of the core/shell polymer or the polymer component (b) is the shell of the core/shell polymer. The dispersion of the melt-processible PTFE within the PFA matrix includes all manner of distribution of this PTFE within the PFA matrix of the melt blend and the article formed therefrom.

The composition of the article formed (derived) from the melt blend of core/shell polymer of the present invention is the same as the composition of the melt blend and exhibits the improvement in tensile strength as compared to the same composition insofar as polymer components and amounts are concerned but obtained by melt mixing of these polymers separately supplied.

Preferably, the article derived from the melt blend of the core/shell polymer of the present invention is essentially in the final shape desired for application of the article, i.e. some finishing such as de-burring may be necessary to obtain the final shape of the article, depending on the melt fabrication process used to form the article.

The tetrafluoroethylene/perfluoro(alkyl vinyl ether) copolymer (polymer component (a)), whether the core or shell of the core/shell polymer of the present invention, is melt flowable by itself and imparts melt flowability to the core/shell polymer. The copolymer is also melt fabricable by itself and imparts melt fabricability to the core/shell polymer, i.e. the core/shell polymer of the present invention is melt-fabricable. By melt fabricable is meant that the copolymer and the core/shell polymer are both sufficiently flowable in the molten state that each can be fabricated by melt processing such as extrusion to produce articles having sufficient strength so as to be useful. Preferably this sufficient strength is characterized by a tensile strength of at least 2500 psi (17.3 MPa), exhibited both by the copolymer by itself and the core/shell polymer of the present invention

The melt flow rate (MFR) of the copolymer is preferably at least 4 g/10 min up to 50 g/10 min, more preferably up to 20 g/10 min, as measured using the extrusion plastometer described in ASTM D-1238 under the conditions disclosed in ASTM D 3307, namely at a melt temperature of 372° C. and under a load of 5 kg. This imparts high melt flowability to the core/shell polymer along with high tensile strength.

The polymer component (a) is commonly referred to as PFA, it being a copolymer of tetrafluoroethylene (TFE) and perfluoro(alkyl vinyl ether) (PAVE). Preferably, the PAVE is a perfluoroalkyl group that is linear or branched, and contains 1 to 5 carbon atoms. For brevity, the polymer component (a) of the core/shell polymer of the present invention may simply be referred to herein as PFA. Preferred PAVE monomers are those in which the perfluoroalkyl group contains 1, 2, 3 or 4 carbon atoms, respectively known as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/perfluoro(methyl vinyl ether)/perfluoro(propyl vinyl ether) copolymer, sometimes called MFA by the manufacturer, but included as PFA herein. PFA can have a melting temperature of 280° C. to 312° C., depending on the identity of the PAVE and its amount in the PFA. The selection of the PAVE and its amount in the PFA as the polymer component (a), whether as the core or the shell of the core/shell polymer of the present invention, is preferably such that the PFA has a melting temperature of 300° C. or greater. It is preferred that the maximum amount of PAVE present in the copolymer is less than 5 wt %, more preferably 4.8 wt % or less. Preferably the minimum amount of PAVE is 2 wt % or greater. The preferred amount of PAVE is 3.0 to 4.5 wt %. The preferred PAVE for each of these amounts and for each of the MFRs and melting temperatures mentioned above is PPVE. The use of PPVE in the PFA contributes to the ability of the PFA to have a high melting temperature, e.g. of 300° C. or greater, while exhibiting good melt fabricability. The amounts of PAVE are based on the total weight of the copolymer, the remainder to total 100 wt % being TFE. Examples of PFA are disclosed in U.S. Pat. Nos. 3,635,926 (Carlson) and 5,932,673 (Aten et al.). The copolymer (PFA) whether the core or shell of the core/shell polymer is a fluoroplastic, not a fluoroelastomer.

The PFA component (polymer component (a)) of the core/shell polymer of the present invention is not the fluoropolymer commonly known as FEP, which is a copolymer of tetrafluoroethylene and hexafluoropropylene (HFP), which optionally may contain a small amount of PAVE comonomer as a modifier of the FEP. Even when a small amount of PAVE is present in FEP, the amount of HFP present in the FEP is much greater, with the result that FEP has a lower melting temperature than PFA, i.e. no greater than 275° C., but usually no greater than 265° C.

With respect to the melt-processible PTFE used in the present invention as polymer component (b) of the core/shell polymer, its melt flowability results from its low molecular weight, generally far less than 500,000 (Mn). This is in contrast to PTFE, which is non-melt flowable in the molten state, arising from its extremely high molecular weight, which is for example far greater than 1,000,000 (Mn). The non-melt flowability of PTFE is far less than indicated by zero MFR. While the low molecular weight of the melt-processible PTFE enables it to be melt flowable so as to be melt processible, this polymer by itself is not melt fabricable, i.e. an article molded from the melt of melt-processible PTFE is useless, by virtue of its extreme brittleness. Because of its low molecular weight (relative to non-melt-flowable PTFE), it has no strength. An extruded filament of melt-processible FIFE is so brittle that it breaks into segments upon melt spinning as discussed above. Compression molded test specimens cannot be made for tensile testing of the melt-processible PTFE because the test specimens crack or crumble when removed from the compression mold. In effect, the melt-processible PTFE has no (0) tensile strength.

While the melt-processible PTFE has low molecular weight, it nevertheless has sufficient molecular weight to be solid up to high temperatures, e.g. having a melting temperature of 300° C. and higher, more preferably 310° C. and higher, even more preferably, 320° C. and higher. Preferably, the melt-processible PTFE has a higher melting temperature than the melting temperature of the PFA, preferably at least 5° C. higher. Preferably, the melting temperature of the PFA is high enough, however, that the melting temperature of the melt-processible PTFE is less than 20° C. greater than that of the PFA, more preferably no greater than 18° C. above the melting temperature of the PFA, whether the melt-processible PTFE is the core or the shell of the core/shell polymer.

The melt-processible PTFE can also be characterized by high crystallinity, preferably exhibiting a heat of crystallization of at least 50 J/g. Heat of crystallization is determined as disclosed in U.S. Pat. No. 5,603,999, and is determined on cooling from the first heat (first melting) of the polymer.

The melt-processible PTFE can also be characterized by its melt flowability, which can be characterized by a melt flow rate (MFR) preferably of 0.8 g/10 min or greater and more preferably 2 g/10 min or greater, and even more preferably 5 g/10 min or greater, as measured in accordance with ASTM D 1238, at 372° C. using a 5 kg weight. The MFR of the melt-processible PTFE is preferably no greater than 100 g/10 min.

The melt flow rates of the PFA and the melt-processible PTFE are preferably such that the core/shell polymer exhibits an MFR of 4 g/10 min or greater and up to 50 g/10 min or less. More preferably, the core/shell polymer exhibits an MFR of 4 to 20 g/10 min. All melt flow rates disclosed herein are determined on non-heat-aged polymer unless otherwise indicated. The MFR of the core/shell polymer is determined on its melt blend, but is considered to be the MFR of the core/shell polymer.

The melt-processible PTFE becomes the core or shell of the core/shell polymer of the present invention by polymerization, not by radiation degradation of non-melt flowable PTFE.

The melt-processible PTFE is frequently referred as PTFE micropowder in the literature, which is also another way of distinguishing this polymer from the high molecular weight, non-melt flowable PTFE, which may simply be referred in the literature as PTFE.

The proportions of PFA and melt-processible PTFE in the core/shell polymer of the present invention are preferably those that (i) satisfy the MFR preferences for the core/shell polymer and/or (ii) provide the improvement of 10% or greater in tensile strength as discussed above. It is preferred that the improvement in tensile strength of the core/shell polymer is 15% or greater. It is preferred also that the proportion of melt processible PTFE in the core/shell polymer is 18 wt % or greater. It is further preferred that maximum amount of melt-processible PTFE in the core/shell polymer is 40 wt % or less and more preferably, 35 wt % or less and even more preferably 30 wt % or less, thereby defining such ranges as 15 or 18 wt % to 45 wt %, 15 or 18 wt % to 40 wt %, 15 or 18 wt % to 35 wt %, and 15 or 18 wt % to 30 wt % melt-processible PTFE, the remainder of the core/shell polymer to total 100 wt % being PFA, whether the PFA is the core or the shell of the core/shell polymer. These compositions apply to any and all of the FFA compositions, MFRs of the PFA and melt-processible PTFE, and improvements in tensile strength mentioned above.

The core/shell polymer of the present invention can be heat aged to further increase its tensile strength. The heat aging is effective to provide this result, which is preferably an increase in tensile strength as compared to the unaged core/shell polymer of 10% or greater. Preferably, the heat aging is carried out with the core/shell polymer in the form of the article formed from the melt blend of the core/shell polymer and with the resulting composition of the melt blend and thus of the article remaining in the solid state. By solid state is meant that the article derived from the core/shell polymer does not lose its shape during the heat aging. This represents the upper limit of the temperature/time to which the article is exposed during heat aging. The shape of the article subjected to heat aging is preferably essentially its final shape. The heat aging temperature is preferably 280° C. or greater, preferably 300° C. or greater, but less than the melting temperature of the (b) melt-processible PTFE. The heat aging time will depend on the temperature at which heat aging is carried out and the improvement in tensile strength desired. For each of the heat aging temperatures mentioned above, the heat aging time is preferably at least 4 hr, more preferably at least 1 day and most preferably at least 7 days.

The improvement in tensile strength obtained by heat aging is preferably in addition to the improvement in tensile strength exhibited by the article derived from the melt blend of the core/shell polymer. The dispersion of melt-processible PTFE within the FFA matrix forming the article derived from the core/shell polymer is essentially unchanged by the heat aging process regardless whether the melt-processible PTFE in the article comes from the core or from the shell of the core/shell polymer.

The heat aging can be carried out by placing the core/shell polymer or article made therefrom in an oven, which is heated to the desired temperature for the desired time. The oven may be a circulating air oven.

While the improvements in tensile strength before and after heat aging are obtained from an article molded from a melt blend of the core/shell polymer, the source of these improvements is from the core/shell polymer from which the melt blend and the article molded therefrom are derived. The core/shell polymer or heat aged core/shell polymer can therefore be considered to exhibit these improvements. The core/shell polymer is useful for melt spinning as in U.S. Pat. No. 6,436,533 or for fabrication into articles such as electrical insulation by melt draw-down extrusion coating of electrical conductor.

### EXAMPLES

The tensile strength and elongation (to break) are determined by the procedure of ASTM D 638-03 as modified by ASTM D3307 section 9.6 on dumbbell-shaped test specimens 15 mm wide by 38 mm long and having a thickness of 5 mm, stamped out from 60 mil (1.5 mm) thick compression molded plaques. Tensile strength and elongation is measured at 23° C.±2° C.

The compression molding of the plaques is carried out on composition made by melt mixing the core/shell polymer in the Brabender® extruder as described in the Comparison Example. The compression molding is carried out under a force of 20,000 lbs (9070 kg) at a temperature of 343° C. to make 7×7 in (17.8×17.8 cm) plaques. In greater detail, 80 g of the composition is added to a chase which is 63 mil (1.6 mm) thick. The chase defines the 17.8×17.8 cm plaque size. To avoid sticking to the platens of the compression molding press, the chase and composition filling are sandwiched between two sheets of aluminum. The combination of the chase and the aluminum sheets (backed up by the platens of the press) form the mold. The press platens are heated to 343° C. The total press time is 10 min, with the first one minute being used to gradually reach the press force of 20,000 lb (9070 kg) and the last minute being used for pressure release. The sandwich is then immediately transferred to a 70-ton (63560 kg) cold press, and a force of 20,000 lb (9070 kg) is applied to the hot compression molding for 5 min. The sandwich is then removed from the cold press and the compression molded plaque is removed from the mold. The dumbbell test specimens (samples) are the cut from the plaque using the steel the described in FIG. 1 of ASTM D 3307.

The procedure for determining melting temperatures disclosed herein is by DSC (differential scanning calorimeter) analysis in accordance with ASTM D3418-08. The calorimeter used is TA Instruments (New Castle, Del., USA) Q1000 model. The temperature scale has been calibrated using (a) 3 metal melting onsets: mercury (−38.86° C.), indium (156.61° C.), tin (231.93° C.) and (b) the 10°/min heating rate and 30 ml/min dry nitrogen flow rate. The calorimetric scale has been calibrated using the heat of fusion of indium (28.42 J/g) and the (b) conditions. The melting temperature determinations are carried out using the (b) conditions. The melting temperatures disclosed herein are the endothermic peak melting temperature obtained from the first or second heating (melting) of the polymer following the heat-up/cool-down/heat-up schedule set forth in U.S. Pat. No. 5,603,999, except that the highest temperature used is 350° C. For the PFA, and the core/shell polymer compositions (melt blend), the melting temperature is from the first heat. For the melt-processible PTFE, the melting temperature is from the second heat.

The PAVE content of PFA component is determined by infrared analysis on compression molded film in accordance with the procedure disclosed in U.S. Pat. No. 4,380,618 for the PAVE when it is PPVE. The infrared analyses for other PAVE comonomers are disclosed in the literature on polymers containing such other comonomers. For example, the infrared analysis for PEVE is disclosed in U.S. Pat. No. 5,677,404. The infrared analysis of the PAVE content of the PFA in the core or shell of the core/shell polymer is carried out on the compression molded film of the core/shell polymer, which obtains a measured value based on the entire core/shell polymer. The compression molding of the core/shell polymer converts it to a melt blend, which is solidified as the film for infrared analysis. The PAVE content of the PFA component of the core/shell polymer is determined using the equation disclosed under Example 1.

The water used to form the aqueous dispersion polymerization medium in the Examples is deionized deaerated water.

### Comparison Example

The melt-processible PTFE used in this Example has a heat of crystallization of 64 J/gm, melting temperature of 325° C. (second heat), MFR of 17.9 g/10 min, and is in a powder form having an average particle size of 12 micrometers. The PFA used in this Example has a PPVE content of 4.3 wt %, a melting temperature of 308° C., an MFR of 14 g/10 min and is in the form of pellets obtained by extrusion of the PFA and cutting the extruded strand into pellets.

These polymers are dry and melt blended together to form a composition of 20 wt % of the melt processible PTFE and 80 wt % of the PFA by the following procedure: A Brabender® single screw extruder is used. The extruder is equipped with a 1-¼ in (3.2 cm) diameter screw having a Saxton-type mixing tip and the extruder has an LID ratio of 20:1. The temperature profile in the extruder is as follows: zone 1=315° C., zone 2=321° C., zone 3=332° C., zone 4=338° C., zone 5 and die=349° C., The extruder screw is operated at 120 rpm. Pellets of the PFA and the melt-processible PTFE powder are dry blended, followed by melt mixing in a Brabender® extruder. The dry blending and melt mixing are carried out in two steps. In the first step, one-half of the total amount of the melt-processible PTFE is dry blended with the PFA pellets and then passed through the extruder, which extrudes pellets of this mixture. In the second step, these pellets are dry mixed with the other one-half of the total amount of melt-processible PTFE and passed through the Brabender extruder to produce extruded pellets. The total amount of the melt-processible PTFE blended and melt mixed with the PFA produces the desired composition containing 20 wt % of the PTFE and 80 wt % of the PFA.

The tensile strength of this composition is 2955 psi (20.4 MPa)

### Example 1

### Melt Processible PTFE Core/PFA shell

The core/shell polymer in which the core of melt-processible PTFE constitutes 20 wt % of the core/shell polymer and the shell of PFA constitutes 80 w % of the core/shell polymer is prepared in this Example. Precharge to the polymerization reactor:
54.0 lb (24.5 kg) water
240 mL 20 wt % aqueous ammonium perfluorooctanoate solution
5.0 g Krytox® 157FSL functional fluid (carboxylic acid)
   Solutions and liquids pumped into the reactor:
1. 2.6 g ammonium persulfate (APS) and 28 g disuccinic acid peroxide (DSP) diluted to 1000 mL with water (initiator solution 1)
2. PPVE (neat)
3. 2.0 g APS diluted to 1000 mL with water (initiator solution 2)
   Operating procedure:
1. Pressure test at 25° C. and 350 psig. Agitate at 50 rpm.
2. Evacuate and purge three times with TFE at 25° C.
3. Pressurize reactor with ethane to give a 29.5 in (74.9 cm) Hg pressure rise at the field gauge.
4. Bring the reactor to 90° C. and allow it to equilibrate, agitating at 50 rpm.
5. Pressure the reactor to 350 psig (3617 kPa) with TFE.
6. Pump 400 mL of initiator solution 1 into the reactor at 50 mL/min.
7. Allow a 10 psig (102.3 kPa) pressure drop to determine kickoff at 90° C.
8. After kickoff, adjust the agitator to react 4 lbs (1.81 kg) of TFE in 13 min. Maintain pressure at 350 psig (3617 kPa).
9. After 4 lbs (1.81 kg) TFE have been fed after kickoff, close the TFE feed valve.
10. Turn off the agitator and vent the reactor. Evacuate the reactor.
11.Turn on the agitator to 50 rpm and cool to 25° C.
12. Turn off the agitator then pressure the reactor with ethane to give an 8 in (20.3 cm) Hg pressure rise at the field gauge.
13. Turn on the agitator to 50 rpm and bring the reactor to 72° C. Allow to equilibrate.
14. Add 200 mL PPVE to the reactor.
15. Pressure the reactor to 250 psig (2558 kPa) using TFE.
16. Inject Initiator Solution 2 at 5 mL/min and PPVE 2 mL/min for the remainder of the batch.
17.Adjust the pressure to allow 15.4 lbs (6.98 kg) TFE to react in 96 min. Maintain the agitator at 50 rpm.
18. After 15.4 lbs (6.98 kg) of TFE has been consumed in the second phase of the polymerization, shut off the TFE, PPVE, and initiator feeds, stop the agitator, and vent the reactor.
19. When the reactor pressure has reached 5 psig (51.7 kPa), sweep the reactor with nitrogen.
20. Cool to 50° C. before removing the aqueous dispersion of core/shell polymer from the reactor.

The RDPS of the core/shell polymer is 0.182 micrometers. The composition of the core/shell polymer is determined as from the following equations:

% Core=(core TFE/total TFE)×(100% measured PPVE)

% PPVE in PFA shell=(100% ×measured PPVE %)/(100% Core)

In these equations: All %s are wt %. The “% PPVE in PFA shell” is “% PPVE in PPVE core” in applying these calculations to Example 2, “Total TFE” is the amount of TFE consumed (polymerized) in the polymerization reactions, i.e. 1.81+6.98=8.79 kg. “Measured PPVE” is wt % PPVE (3.478 wt %) determined by infrared analysis on the core/shell polymer as described above.
These equations are applied to this Example as follows:

% core=1.81 kg TFE/8.79 kg TFE×(100−3.478% PPVE)=19.9 wt % core

PPVE in PFA shell=100%×3.478 wt %/(100−19.9 wt % core)=4.34 wt % PPVE in PFA shell

The core of melt-processible PTFE is formed in steps 1-11, and the shell of TFE/PPVE copolymer is formed in steps 12-18. The polymerization conditions to make the core match those to make melt-processible PTFE by itself having an MFR of 17.9 g/10 min, and the polymerization conditions to make the TFE/PPVE copolymer shell match those conditions to make the copolymer by itself having 4.3 w % PPVE and MFR of 14 g/10 min. After coagulation by vigorous agitation of the aqueous polymerization medium, the core/shell polymer particles are isolated from the aqueous medium by filtration and then drying in a convection air oven. The MFR of the core/shell polymer is 5.5 g/10 min and its tensile strength is 3748 psi (25.9 MPa). This tensile strength is 27% greater than the tensile strength of the composition of the Comparison Example having the same polymer components in the same proportion.

### Example 2

### PFA Core/Melt -Processible PTFE Shell

The core/shell polymer in which the core of PFA constitutes 80 wt % of the core/shell polymer and the shell of melt-processible PTFE constitutes 20 w % of the core/shall polymer is prepared in this Example.

The polymerization, coagulation and drying procedures of Example 1 are repeated except that the steps 12-17 are carried out prior to steps 3-9, so that the TFE/PPVE copolymerization is carried out first to produce the core of the core/shell polymer, followed by polymerization to produce the melt-processible PTFE shell.

The RDPS of the core/shell polymer is 0.182 micrometers. The MFR of the core/shell polymer is 8.9 g/10 min and its tensile strength is 3441 psi (23.7 MPa). This tensile strength is 16% greater than the tensile strength of the composition of the Comparison Example having the same polymer components in the same proportion.

The improvement in tensile strength for the compositions derived from the core/shell polymers of Examples 1 and 2 as compared to the composition from the Comparison Example is without any appreciable sacrifice in elongation. Elongations of the compositions of Examples 1 and 2 are greater than 315%.

### Example 3

### Heat Aging of the Core/Shell Polymer

The core/shell polymers of Examples 1 and 2 in the form of tensile strength test specimens are heat aged in an aft circulating oven for 7 days at 300° C. The tensile strength of the core/shell polymer of Example 1 increases from 3748 psi to 4495 psi, an increase of 20%. The tensile strength of the core/shell polymer of Example 2 increases from 3441 psi to 4048 psi, an increase of 17.6%.

The same heat aging of tensile strength test specimens from the composition of the Comparison Example produces no increase in tensile strength.

Elongations of the compositions of Examples 1 and 2 after heat aging are greater than for the composition of the Comparison Example after the same heat aging.

1. Core/shell polymer wherein the core comprises one of (a) melt-fabricable tetrafluoroethylene/perfluoro(alkyl vinyl ether) copolymer and (b) melt-processible polytetrafluoroethylene, and the shell comprises the other of (a) and (b), wherein the amount of (b) in said core/shell polymer is 15 to 45 wt % based on the total weight of (a) and (b).

2. The core/shell polymer of claim 1 having a melt flow rate of at least 4 g/10 min.

3. The core/shell polymer of claim 1 wherein (a) has a melt flow rate of at least 4 g/10 min.

4. The core/shell polymer of claim 1 wherein the amount of perfluoro(alkyl vinyl ether) present in (a) is less than 5 wt % based on the total weight of (a).

5. The core/shell polymer of claim 1 wherein (b) as a melt flow rate of at least 0.8 g/10 min.

6. The core/shell polymer of claim 1 wherein (a) is said core and (b) is said shell.

7. The core/shell polymer of claim 6 wherein the amount of (b) in said core/shell polymer is 15 to 45 wt % based on the total weight of (a) and (b).

8. The core/shell polymer of claim 1 wherein (a) is said shell and (b) is said core.

9. The core/shell polymer of claim 8 wherein the amount of (b) in said core/shell polymer is 15 to 45 wt % based on the total weight of (a) and (b).

10. A process comprising heat aging a core/shell polymer wherein the core comprises one of (a) melt-fabricable tetrafluoroethylene/perfluoro(alkyl vinyl ether) copolymer and (b) melt-processible polytetrafluoroethylene and the shell comprises the other of (a) and (b) to increase the tensile strength of said polymer, wherein the amount of (b) in said core/shell polymer is 15 to 45 wt % based on the total weight of (a) and (b).

11. The process of claim 10 wherein (a) is said core and (b) is said shell.

12. The process of claim 10 wherein (a) is said shell and (b) is said core.
